(19) United States
(12) Patent Application Publication
(10) Pub. No.: US 2018/0359623 A1
(43) Pub. Date: Dec. 13, 2018

(54) WIRELESS TERMINAL AND COMMUNICATION METHOD OF THE WIRELESS TERMINAL

(71) Applicant: WISOL CO., LTD., Gyeonggi-do (KR)

(72) Inventors: SeogHyun KIM, Gyeonggi-do (KR); HeeSang LEE, Gyeonggi-do (KR)

(21) Appl. No.: 16/001,170

(22) Filed: Jun. 6, 2018

(30) Foreign Application Priority Data
Jun. 12, 2017 (KR) 10-2017-0072904

(51) Int. Cl. H04W 4/80; H04W 88/10; H04W 16/14; H04W 72/04; H04W 4/02

(52) U.S. Cl. CPC H04W 4/80; H04W 88/10; G01S 19/42; H04W 72/0453; H04W 4/025; H04W 16/14

(57) ABSTRACT

Disclosed is a wireless terminal including a global positioning system (GPS) communication portion, a wireless fidelity (Wi-Fi) communication portion, a low-power wide-area network (LPWAN) communication portion, an information storage portion, a power supply portion, and a control portion. Here, the control portion controls the LPWAN communication portion to access a server which services the LPWAN by using at least one of the frequency band information mapped with the GPS coordinate information and access point (AP) position information of an AP which the Wi-Fi communication accesses.

### CROSS-REFERENCE TO RELATED APPLICATION

This application claims priority to and the benefit of Korean Patent Application No. 10-2017-0072904, filed on Jun. 12, 2017, the disclosure of which is incorporated herein by reference in its entirety.

### FIELD

The present invention relates to a wireless terminal configured to operate on an unlicensed frequency band, and more particularly, to a wireless terminal for quickly accessing a network with respect to an unlicensed frequency band and a communication method of the wireless terminal.

### BACKGROUND

As development of an information & communication technology (ICT), structures of a large majority of peripherally existing devices have been changed to be mutually connected and interwork through a communication network. Through this, Internet of things (IoT) which is a society in which electronic devices are mutually connected to communicate with one another through a mobile network and Internet, that is, which is a new connected ecological system such as hyper-connected society in which a thing and a thing are connected through a network has been constructed.

As IoT becomes a preoccupation in the ICT industry, investment and attempts to IoT networks for generating values thereof have extended and IoT network providers have appeared in technology-advanced countries. As an example, IoT network provides such as Sigfox, LoRa Alliance, Weightless, and the like have appeared in France, Spain, Netherlands, the UK, the U.S.A, and the like. Particularly, up to now, exclusive communication networks for IoT in a limited space in house by utilizing a short-distant communication method such as Bluetooth, Zigbee, and the like have been constructed. However, recently, it has become a hot issue to construct an exclusive communication network for IoT by using a low-power wide-area network (LPWAN) utilizing an ultra narrow band (UNB) technology.

However, IoT wireless terminals, which provide low-powered narrow band services using the LPWAN, have a limitation that a quick access to a network is not performed while moving between continents or between countries because position information with respect to IoT wireless terminals are unobtainable or frequency regulations for each country are different.

### SUMMARY

It is an aspect of the present invention to provide a wireless terminal configured to check a position thereof and check an accessible network stored in the wireless terminal according to the position to quickly access the network, and a communication method of the wireless terminal.

According to one aspect of the present invention, a wireless terminal includes a global positioning system (GPS) communication portion which receives GPS coordinate information from a satellite, a wireless fidelity (Wi-Fi) communication portion configured to transmit an receive data by using a first frequency band among unlicensed frequency bands for wireless communications, a low-power wide-area network (LPWAN) communication portion configured to transmit an receive data by using a second frequency band corresponding to an LPWAN among the unlicensed frequency bands, an information storage portion configured to store frequency band information mapped with the GPS coordinate information received from the GPS communication portion, a power supply portion configured to supply power for operations of the GPS communication portion, the Wi-Fi communication portion, and the LPWAN communication portion, and a control portion configured to control the GPS communication portion, the Wi-Fi communication portion, the LPWAN communication portion, the information storage portion, and the power supply portion. Here, the control portion controls the LPWAN communication portion to access a server which services the LPWAN by using at least one of the frequency band information mapped with the GPS coordinate information and access point (AP) position information of an AP which the Wi-Fi communication accesses.

The second frequency band may include at least one of 865 GHz, 868 GHz, 902 GHz, 916 GHz, 920 GHz, 923 GHz, and 925 GHz.

When the frequency band information mapped with the received GPS coordinate information is present in the information storage portion, the control portion may set a frequency band and transmission power for accessing the server by using the mapped frequency band information and may perform control to transmit the GPS coordinate information to the server according to the set frequency band and transmission power.

When frequency band information mapped with the received GPS coordinate information is not present in the information storage portion, the control portion may perform control to increase a wake-up cycle for operation of the wireless terminal.

When the GPS coordinate information is not received from the GPS communication portion, the control portion may determine whether the AP is present around. When identifier (ID) information of the AP is received from the AP through the Wi-Fi communication portion, the control portion may obtain the AP position information with respect to the AP and may perform control to transmit the obtained AP position information to the server.

When the ID information includes at least one of a basic service set ID (BSSID) and an Internet protocol (IP) address of the AP, the control portion may perform control to obtain the AP position information corresponding to the BSSID by accessing an open AP or may perform control to obtain the AP position information corresponding to the ID address stored in the information storage portion.

When the ID information of the AP is not obtained through the Wi-Fi communication portion, the control portion may control the LPWAN communication portion to scan a frequency band of the LPWAN and may perform control to transmit an access message to the server according to transmission power corresponding to the frequency band of the LPWAN, which is searched for according to scanning.

According to another aspect of the present invention, a communication method of a wireless terminal includes determining whether a wake-up event occurs, determining whether GPS coordinate information is received from a satellite when it is determined that the wake-up event has occurred, and accessing a server which services an LPWAN among unlicensed frequency bands by using at least one of frequency band information mapped with the GPS coordinate information and AP position information of an AP which services the unlicensed frequency bands, according to whether the GPS coordinate information is received.

The accessing the server may include determining whether the frequency band information mapped with the GPS coordinate information is present when the GPS coordinate information is received, setting a frequency band and transmission power for accessing the server by using the mapped frequency band information when the frequency band information mapped with the GPS coordinate information is present, and transmitting the GPS coordinate information to the server through the LPWAN according to the set frequency band and transmission power.

The accessing the server may further include increasing a wake-up cycle for operation of the wireless terminal when the frequency band information mapped with the GPS coordinate information is not present.

The accessing the server may further include determining whether the AP is present around when the GPS coordinate information is not received, receiving ID information of the AP from the AP when the AP is present, obtaining the AP position information with respect to the AP by using the received ID information, and transmitting the obtained AP position information to the server.

The obtaining of the AP position information with respect to the AP by using the received ID information may include, when the ID information comprises at least one of a BSSID and an IP address of the AP, obtaining the AP position information corresponding to the BSSID by accessing an open AP or obtaining the AP position information corresponding to the ID address stored in the wireless terminal.

The accessing the server may further include scanning a frequency band of the LPWAN when the AP is not present, setting a second frequency band corresponding to the frequency band of the LPWAN, which is searched for according to scanning of the frequency band, and transmission power, and transmitting an access message to the server according to the set frequency band and transmission power.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a system configuration block diagram illustrating a network environment of a wireless terminal according to one embodiment of the present invention;

FIG. 2 is a block diagram illustrating one example of the wireless terminal according to one embodiment of the present invention;

FIG. 3 is a referential view illustrating global positioning system (GPS) coordinate information stored in an information storage portion and frequency band information corresponding thereto;

FIGS. 4A and 4B are timing diagrams illustrating that a wake-up cycle of the wireless terminal is increased under the control of a controller shown in FIG. 2;

FIG. 5 is a block diagram illustrating one example of a communication method of a wireless terminal according to one embodiment of the present invention;

FIG. 6 is a flowchart illustrating an operation of accessing a server of a low-power wide-area network (LPWAN) and transmitting GPS coordinate information thereto, which is shown in FIG. 5; and

FIG. 7 is a flowchart illustrating an operation of accessing the server of the LPWAN and transmitting position information of an access point thereto, which is shown in FIG. 5.

### DETAILED DESCRIPTION

Hereinafter, exemplary embodiments of the present invention will be described in detail with reference to the attached drawings.

The embodiments of the present invention are provided to more completely explain the present invention to one of ordinary skill in the art. The following embodiments may be modified into a variety of different forms, and the scope of the present invention is not limited thereto. The embodiments are provided to make the disclosure more substantial and complete and to completely convey the concept of the present invention to those skilled in the art.

The terms used herein are to explain particular embodiments and are not intended to limit the present invention. As used herein, singular forms, unless contextually defined otherwise, may include plural forms. Also, as used herein, the term “and/or” includes any and all combinations or one of a plurality of associated listed items. Hereinafter, the embodiments of the present invention will be described with reference to the drawings which schematically illustrate the embodiments.

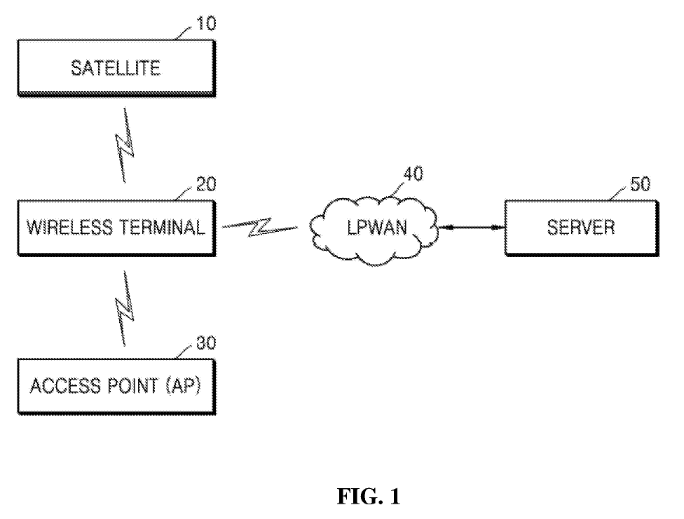

FIG. 1 is a system configuration block diagram illustrating a network environment of a wireless terminal according to one embodiment of the present invention.

Referring to FIG. 1, a network environment of a wireless terminal may include a satellite 10, a wireless terminal 20, an access point (AP) 30, a low-power wide-area network (LPWAN) 40, and a server 50.

The satellite 10 provides the wireless terminal 20 with global positioning system (GPS) information according to a GPS. Three or more of such satellites 10 may provide the wireless terminal 20 with GPS coordinate information. The GPS coordinate information provided by the satellite 10 may be GPS coordinate information for measuring a standard position using a coarse/acquisition (C/A) code.

The wireless terminal 20 is a wireless communication device capable of accessing the server 50 through the LPWAN 40. For example, the wireless terminal 20 may be an Internet of things (IoT) device or a wearable device. The IoT device may include a variety of embedded systems such as a home appliance, a mobile device, a computer, and the like, and each of things may include an identifier (ID) for distinguishing itself, a communication function, a data-processing function, and the like. For example, the IoT device may include a bulb, a variety of sensors, an electric or gas meter, a sprinkler, a fire alarm, a thermostat, a streetlamp, a toaster, a sporting apparatus, a hot water tank, a heater, a boiler, and the like. Also, the wearable device may include, for example, at least one of smart glasses, a head-mounted device (HMD), electronic clothing, an electronic bracelet, an electronic collar, an electronic appcessory, an electronic tattoo, a smart mirror, and a smart watch.

The wireless terminal 20 may include, as main functions thereof, a sensing function, a wired or wireless communication and network infrastructure function, and an IoT service interface function. First, the sensing function may collect sensing signals from a temperature sensor, a humidity sensor, a heat sensor, a magnetic sensor, a gas sensor, an altitude sensor, an illuminance sensor, an ultrasonic sensor, a synthetic aperture radar, a position sensor, a motion sensor, an image sensor, and the like. For this, the wireless terminal 20 may include the above-described sensors or may receive sensed signals from the sensors provided as independent modules. The wireless terminal 20 may transmit a sensed signal or a message to be transmitted, in an uplink packet form to the server 50 through the LPWAN 40 by using a broadcasting method.

The wireless terminal 20 may perform uplink data transmission and receive downlink data every certain cycle unit and the like to minimize battery consumption or may cut off network connection to minimize battery consumption when there is no download data reception. That is, for saving power, the wireless terminal 20 may change to a wake-up mode at certain cycles to perform a message uplink operation or a network scanning operation and may return to a sleep mode after the message uplink operation or the scanning operation to minimize power consumption. The certain cycle may be set according to use of a user at least at a cycle of one minute or more.

The AP 30 is wirelessly connected to the wireless terminal 20 and performs a function of relaying for wireless data transmission and reception. Particularly, the AP 30 may wirelessly transmit or receive data through an unlicensed frequency band. The AP 30 may determine a sub band group of the unlicensed band on which interference between service signals is minimized according to channel condition information such as a wide-fidelity (Wi-Fi) transmission and reception signal level or a signal band noise ratio and the like of Wi-Fi transmission and reception signals required for Wi-Fi services within a Wi-Fi service coverage and may perform wireless communication with the wireless terminal 20. For example, the AP 30 may relay data transmission and reception through an unlicensed frequency band of 2.4 GHz or an unlicensed frequency band of 5 GHz. Also, the AP 30 may provide the wireless terminal 20 with a basic service set ID (BSSID) or Internet protocol (IP) address corresponding to ID information of the AP 30 according to an access of the wireless terminal 20. Detailed content corresponding thereto will be described.

The LPWAN 40 refers to a wireless communication network which has a very wide area having a service coverage of 10 km or more, consumes less power, and provides a maximum communication speed at or below several kilobits per second (kbps). For example, the LPWAN 40 is a communication network being applied to the field of IoT devices for reading water meter, gas meter, and electric power meter, or preventing of bicycle theft, and the like which are scattered in a wide area and operate for several years using one battery because a very small amount of data is generated and less frequently exchanged.

For example, the LPWAN 40 includes a long range wide area network (LoRaWAN), a Sigfox network, and the like, which use an unlicensed band of an industrial scientific medical (ISM) band, and a long term evolution (LTE) machine-type communications (MTC) (LTE MTC) network, a narrow band IoT (NB IoT) network, and the like, which use a licensed mobile communication band.

The LPWAN 40 is a network easy to construct an infrastructure without a large number of base stations or repeater equipment and configured to provide higher extendibility and cost-efficiency for embedded applications than that of a cellular network.

The server 50 performs data transmission and reception with the wireless terminal 20 which accesses the LPWAN 40 and provides a user terminal (not shown) with service information corresponding to a signal sensed from the wireless terminal 20. Also, the server 50 may perform data transmission and reception for network management of the LPWAN 40.

Hereinafter, the wireless terminal 20 according to one embodiment will be described in detail.

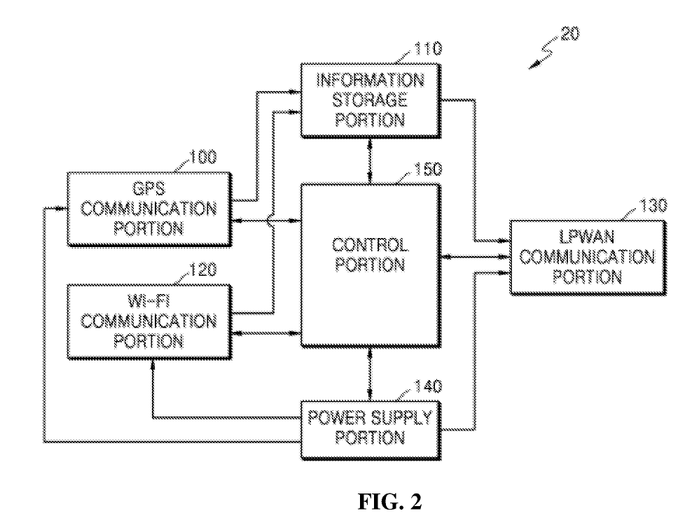

FIG. 2 is a block diagram illustrating one example of the wireless terminal 20 according to one embodiment of the present invention.

Referring to FIG. 2, the wireless terminal 20 may include a GPS communication portion 100, an information storage portion 110, a Wi-Fi communication portion 120, an LPWAN communication portion 130, a power supply portion 140, and a control portion 150.

The GPS communication portion 100 receives GPS coordinate information from the satellite 10. The GPS communication portion 100 may receive GPS coordinate information with respect to the wireless terminal 20 from at least one satellite 10 (for example, three satellites). The GPS communication portion 100 may transmit the received GPS coordinate information to the control portion 150.

Here, the GPS coordinate information received by the GPS communication portion 100 may include latitude, longitude, and time information of the wireless terminal 20. To receive the GPS coordinate information, the GPS communication portion 100 may include an antenna, a low-noise amplifier, a band pass filter, a mixer, a phase locked loop (PLL), a local signal oscillator, a low pass filter, an intermediate frequency (IF) preamplifier, an automatic gain controller (AGC), analog/digital (A/D) converter, a digital signal processor, and the like.

The information storage portion 110 stores GPS coordinate information and frequency band information mapped with the GPS coordinate information. The frequency band information mapped with the GPS coordinate information refers to frequency band information of an LPWAN serviced in an area corresponding to the GPS coordinate information.

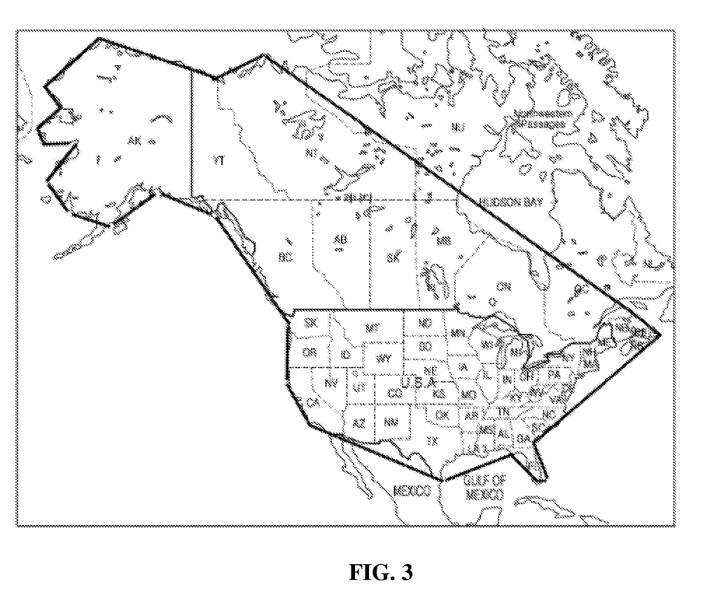

FIG. 3 is a referential view illustrating GPS coordinate information stored in the information storage portion 110 and frequency band information corresponding thereto. Also, following Table 1 show table information which includes GPS coordinate information of areas shown in FIG. 3 and frequency band information mapped therewith.

TABLE 1

| | |
|---|---|
| GPS Coordinate Information | Frequency Band |

| Latitude | Longitude | Information |
|---|---|---|
| 48.380909 | −124.801860 | 902 [GHz] |
| 53.822001 | −133.094402 | |
| 59.146015 | −138.323303 | |
| 59.987903 | −143.863861 | |
| 56.796291 | −154.079265 | |
| 65.576432 | −166.268492 | |
| 65.567621 | −167.948025 | |
| 68.863776 | −166.199804 | |
| 71.263666 | −157.055265 | |
| 69.26916 | −136.0655645 | |
| 70.518465 | −127.859084 | |
| 46.178817 | −60.040978 | |
| 31.440751 | −81.697180 | |
| 25.842471 | −80.329420 | |
| 29.773145 | −85.116580 | |
| 25.945008 | −97.426421 | |
| 32.600382 | −117.258943 | |
| 34.593922 | −120.906303 | |
| 40.028774 | −124.439683 | |
| 46.336432 | −123.097743 | |
| . . . | . . . | |

In FIG. 3, boundary areas of the North American Continent including the U.S.A. and Canada are indicated by a solid line. In Table 1, GPS coordinate information of each of the boundary areas of the North American Continent are indicated by latitudinal coordinates and longitudinal coordinates, and additionally, frequency band information of a LPWAN serviced in the North America corresponding to GPS coordinate information, that is, information on 902 GHz is mapped.

The GPS coordinate information with respect to the North America and the frequency band information corresponding thereto have been shown in FIG. 3 and Table 1 but are not limited thereto. The information storage portion 110, as described in Table 2 which will be described below, may store frequency band information mapped with GPS coordinate information, which is classified for each continent, nation, and/or region, and the frequency band information mapped with the GPS coordinate information may be updated according to a change in a frequency band serviced in each nation or region.

Also, the information storage portion 110 may store IP address information of each of APs. The IP address information corresponding to each of APs may include nation or region information according to an IP address, and the information may be bought through a supplier that sells the information with fee and be prestored in the information storage portion 110.

The Wi-Fi communication portion 120 transmits and receives data using a first frequency band among unlicensed frequency bands for wireless communications. For example, the Wi-Fi communication portion 120 may transmit and receive data using an unlicensed frequency band of 2.4 GHz or an unlicensed frequency band of 5 GHz as the first frequency band.

The Wi-Fi communication portion 120 may support a communication protocol for wireless communications on an unlicensed frequency band, search for the AP 30 around, and perform wireless communications on the basis of a BSSID given by the AP 30 or an IP address thereof. For this, the Wi-Fi communication portion 120 may include an antenna module configured to transmit or receive a wireless signal through the AP 30, a digital signal processor configured to convert the wireless signal into a data signal, a micro control unit (MCU) configured to process data transmitted from the digital signal processor, and the like.

The LPWAN communication portion 130 transmits and receives data using a second frequency band corresponding to an LPWAN among unlicensed frequency bands. The LPWAN communication portion 130 may generally use a frequency band of 1 GHz or less as the second frequency band. Here, the second frequency band may include unlicensed frequency bands of 865 GHz, 868 GHz, 902 GHz, 916 GHz, 920 GHz, 923 GHz, and 925 GHz.

Table 2 is tale information which illustrates each region corresponding to each of the second frequency bands.

TABLE 2

| Region | Frequency Band (GHz) |
|---|---|
| India/Asia | 865 |
| Europe | 868 |
| North America | 902 |
| Israel | 916 |
| Latin America/Asia | 920 |
| Korea/Japan | 923 |
| Venezuela | 925 |

Frequency band information for each region shown in Table 2 may be updated according to a change in frequency band information in each nation or region.

The power supply portion 140 supplies power for operations of the GPS communication portion 100, the Wi-Fi communication portion 120, the LPWAN communication portion 130, and the control portion 150. The power supply portion 140 may receive, convert, and supply commercial power or may supply power to each of components by using a built power supply battery. The battery included in the power supply portion 140 may be a disposable battery or may be a rechargeable battery.

The control portion 150 controls the operations of the GPS communication portion 100, the information storage portion 110, the Wi-Fi communication portion 120, the LPWAN communication portion 130, and the power supply portion 140. For this, the control portion 150 may include a central processing unit (CPU), an application processor, a communication processor, a memory, a timer, or the like. The control portion 150 may perform operations or data processing with respect to controlling and/or communication of each of components of the wireless terminal 20 by using one or more of the CPU, the application processor, and the communication processor. The memory may include a volatile and/or nonvolatile memory and may store a program or data for controlling each of components of the wireless terminal 20. The timer may time a mode change cycle for conversion into a wake-up mode or a sleep mode of the wireless terminal 20.

The control portion 150 performs control such that the LPWAN communication portion 130 accesses the server 50 by using at least one of frequency band information mapped with GPS coordinate information and AP position information of the AP 30 which the Wi-Fi communication portion 120 accesses.

When the GPS coordinate information is received from the GPS communication portion 100, the control portion 150 calls table information stored in the information storage portion 110 and checks whether frequency band information mapped with the GPS coordinate information received through the GPS communication portion 100 is present. For example, when GPS coordinate information corresponding to latitude of 33.758679 and longitude of −118.282376 is received from the GPS communication portion 100, the control portion 150 checks whether frequency band information corresponding to latitude of 33.758679 and longitude of −118.282376 is stored in the information storage portion 110. As shown in FIG. 3 and Table 1, when 902 GHz, which is frequency band information corresponding to latitude of 33.758679 and longitude of −118.282376, is stored in the information storage portion 110, the control portion 150 sets 902 GHz as a frequency band for communication with the server 50 according to 902 GHz which is frequency band information mapped with the GPS coordinate information and sets data transmission power necessary for communication with the server 50 to be matched with the frequency band of 902 GHz. The control portion 150 performs control such that the GPS coordinate information is transmitted to the server 50 according to the set frequency band and transmission power. Accordingly, the LPWAN communication portion 130 may transmit the GPS coordinate information, for example, latitude of 33.758679 and longitude of −118.282376, which is received from the GPS communication portion 100, to the server 50 through the LPWAN 40.

Also, when frequency band information mapped with the received GPS coordinate information is not present in the information storage portion 110, the control portion 150 may perform control to increase a wake-up cycle for operation of the wireless terminal 20.

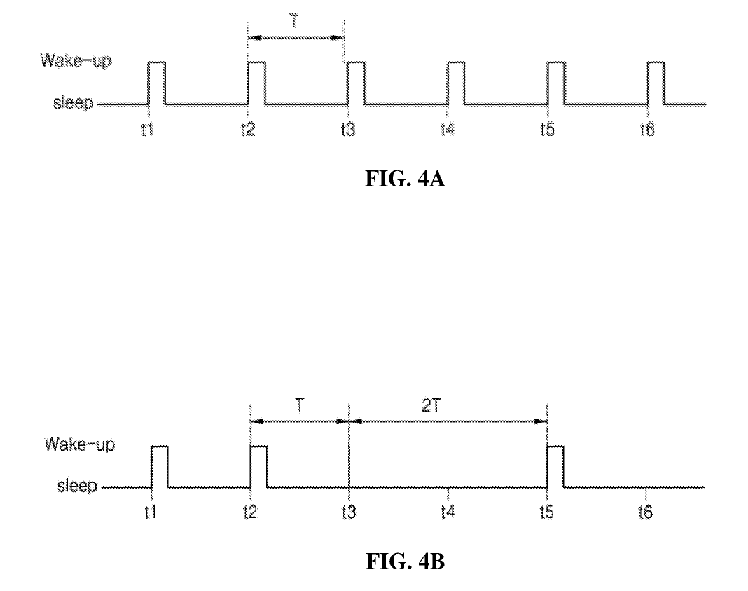

FIGS. 4A and 4B are timing diagrams illustrating that a wake-up cycle of the wireless terminal 20 under is increased the control of the control portion 150 shown in FIG. 2. FIG. 4A illustrates a preset wake-up cycle of the wireless terminal 20, and FIG. 4B illustrates a wake-up cycle changed under the control of the control portion 150.

Referring to FIG. 4A, in the wake-up cycle, a wake-up mode and a sleep mode are generally repeated at certain time intervals (for example, one minute to ten minutes). However, referring to FIG. 4B, when frequency band information mapped with the received GPS coordinate information is not present in the information storage portion 110, the wake-up mode and the sleep mode are repeated at time interval increased than the preset cycle (for example, twice the time intervals) in the wake-up cycle. Here, an increase of the wake-up cycle may be geometrical. For example, when a preset cycle is assumed as T, the wake-up cycle is changed to a cycle 2T twice the preset cycle T when frequency band information mapped with received GPS coordinate information is not present in the information storage portion 110 in the wake-up mode. Then, when frequency band information mapped with the received GPS coordinate information is not present in the information storage portion 110 even in a state woken up to be the cycle 2T, the wake-up cycle is changed to a cycle 4T which is increased twice the cycle 2T. In this way, the wake-up cycle may be geometrically increased to be 8T, 16T, 32T, and the like. Also, the wake-up cycle may increase to a certain time and may reach a maximum value, and then an interval between cycles may be gradually reduced after the maximum value is reached.

Also, the change of the wake-up cycle may be performed while a certain number of the wake-up modes have been repeated. For example, in FIG. 4B, when it is determined that frequency band information mapped with GPS coordinate information is present in the information storage portion 110 at time points at which the wake-up mode is changed three times (for example, time points t1, t2, and t3), the wake-up cycle may increase twice from T to 2T. Then, when it is determined that the frequency band information mapped with the GPS coordinate information is not present in the information storage portion 110 even at a time point at which the wake-up mode has changed three times, the wake-up cycle increases as much as a gap from 2T to 4T.

Meanwhile, when GPS coordinate information is not received from the GPS communication portion 100, the control portion 150 may perform control to obtain AP position information of the AP 30 by using ID information of the AP 30, which is obtained by the Wi-Fi communication portion 120, and to transmit the obtained AP position information to the server 50.

The ID information may include a BSSID of the AP 30 and an IP address of the AP 30. The BSSID is a unique ID present in a header of a packet transmitted through a wireless LAN (WLAN) and is used for distinguishing each WLAN from another WLAN when a WLAN client accesses the BSSID. Particularly, the BSSID is used for distinguishing a basic service set (BSS) of 48 bits at 802.11 which is a standard of WLAN and may generally employ a media access control (MAC) address of the AP 30. An IP address is a unique address value which identifies the AP 30 on the Internet.

When GPS coordinate information is received from the GPS communication portion 100, the control portion 150 determines whether the AP 30 is present around by controlling the Wi-Fi communication portion 120. The Wi-Fi communication portion 120 scans APs around under the control of the control portion 150. The Wi-Fi communication portion 120 may receive ID information, that is, a BSSID and an IP address of at least one of the scanned APs from the corresponding AP.

When the Wi-Fi communication portion 120 receives the ID information of the AP 30 from the AP 30 around, the control portion 150 performs control to obtain AP position information with respect to the AP 30 by using the received ID information and to transmit the obtained AP position information to the server 50.

The control portion 150 confirms whether the AP 30, which transmits the ID information, is an open AP by controlling the Wi-Fi communication portion 120. Whether the AP 30 is an open AP may be confirmed when an additional authentication process is unnecessary. When the AP, which transmits the ID information, is an open AP, the control portion 150 may access the open AP and obtain AP position information corresponding to a BSSID. That is, the control portion 150 may perform control to access the open AP through the Wi-Fi communication portion 120 and may obtain the AP position information corresponding to the BSSID from a position providing server (not shown).

Then, the control portion 150 performs control to transmit the obtained AP position information to the server 50. That is, the control portion 150 may perform control to transmit the AP position information of the AP 30, which is obtained from the position providing server, to the server 50 through the LPWAN communication portion 130. Accordingly, the LPWAN communication portion 130 may transmit the AP position information to the server 50 through the LPWAN 40.

Also, when the AP, which transmits ID information, is not an open AP, the control portion 150 may perform control to check whether AP position information corresponding to an IP address of the ID information is present in the information storage portion 110. Accordingly, when the AP position information corresponding to the IP address is present in the information storage portion 110, the AP position information corresponding to the IP address may be obtained. Then, the control portion 150 may control the LPWAN communication portion 130 to transmit the obtained AP position information to the server 50.

Meanwhile, when the ID information of the AP 30 is not obtained through the Wi-Fi communication portion 120, the control portion 150 may control the LPWAN communication portion 130 to scan a frequency band of the LPWAN 40, may perform control to set transmission power corresponding to a frequency band of the LPWAN 40 detected by scanning, and may perform control to transmit an access message to the server 50 according to the set transmission power.

When GPS coordinate information is not received from the GPS communication portion 100 and no access point is present around or ID information of the AP 30 is not obtained through the Wi-Fi communication portion 120 due to hindrance in communications, the control portion 150 controls the LPWAN communication portion 130 to scan a frequency band of an LPWAN serviced by the server 50. Here, the control portion may perform control to perform a scanning operation on a frequency band for a certain time (for example, four seconds) or more.

Accordingly, the LPWAN communication portion 130 scans a frequency band of an LPWAN capable of accessing the server 50, that is, a second frequency band. The LPWAN communication portion 130 may search for the second frequency band of the LPWAN through frequency scanning. The control portion 150 sets the frequency band of the LPWAN, which is obtained by the LPWAN communication portion 130, that is, the second frequency band as a frequency band for transmitting and receiving data. Then, the control portion 150 may set transmission power for transmitting data to correspond to the set second frequency band. Then, the control portion 150 generates an access message for accessing the server 50 which provides services through the LPWAN. Here, the access message may be a request signal for access of the wireless terminal 20 to the server 50, a service request signal, or the like. The control portion 150 controls the LPWAN communication portion 130 to transmit the generated access message to the server 50 according to the set frequency band and transmission power. Accordingly, the LPWAN communication portion 130 transmits the access message to the server 50 through the second frequency band of the LPWAN.

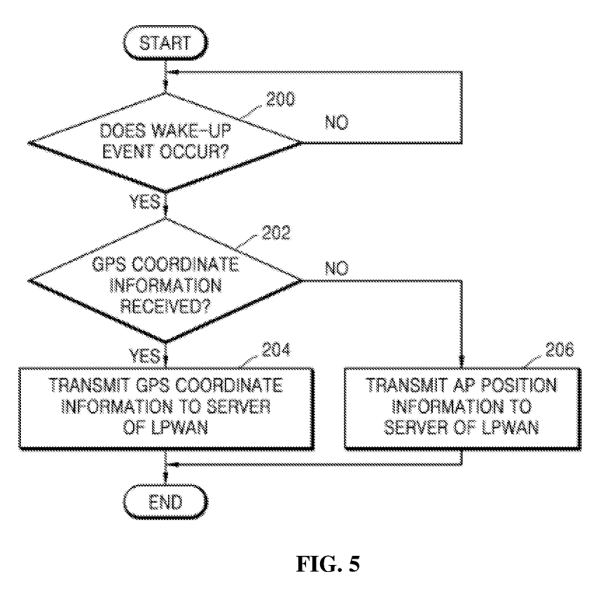

FIG. 5 is a block diagram illustrating one example of a communication method of a wireless terminal according to one embodiment of the present invention.

Referring to FIG. 5, a wireless terminal determines whether a wake-up event occurs (200). The wireless terminal is changed to a wake-up mode or a sleep mode depending on a preset wake-up cycle. When the wireless terminal is changed to the wake-up mode according to the wake-up cycle, the wireless terminal may sense a rising point in time of the wake-up mode and may determine that the wake-up event occurs.

When it is determined in operation 200 that the wake-up event occurs, the wireless terminal determines whether GPS coordinate information is received from a satellite (202). The wireless terminal may periodically or aperiodically receive GPS coordinate information from the satellite. The GPS coordinate information received from the satellite may include latitude, longitude, and time information of the wireless terminal. However, GPS coordinate information may not be received because the wireless terminal is located indoors or due to hindrance in communications with the satellite.

In operation 202, depending on whether the GPS coordinate information is received, at least one of frequency band information mapped with the GPS coordinate information and AP position information of an AP, which services an unlicensed frequency band, is used to access a server, which services an LPWAN, among the unlicensed frequency band (204 and 206). When GPS coordinate information is received from the satellite, the wireless terminal transmits the received GPS coordinate information to the server of the LPWAN by using a frequency band corresponding to the GPS coordinate information. Also, when GPS coordinate information is not received from the satellite, the wireless terminal transmits AP position information of position information of an AP, which is obtained from APs around, to the server of the LPWAN. Hereinafter, operation 204 and operation 206 will be described in detail.

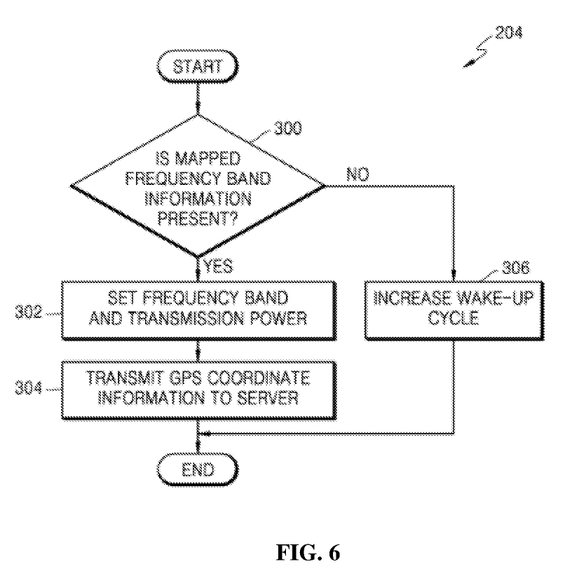

FIG. 6 is a flowchart illustrating operation 204 of accessing the server of the LPWAN and transmitting GPS coordinate information thereto, which is shown in FIG. 5.

Referring to FIG. 6, when GPS coordinate information is received, the wireless terminal determines whether frequency band information mapped with the received GPS coordinate information is present (300). The wireless terminal calls table information stored in a memory space and checks whether the frequency band information mapped with the received GPS coordinate information is present. The frequency band information mapped with the GPS coordinate information may be stored while being classified for each continent, nation, and/or region.

In operation 300, when it is determined that the frequency band information mapped with the GPS coordinate information is present, the wireless terminal sets a frequency band and transmission power for accessing the server by using the mapped frequency band information (302). When the frequency band information mapped with the GPS coordinate information including latitude information and longitude information is present, the wireless terminal sets a frequency band for communicating with the server to correspond to the mapped frequency band information. Also, the wireless terminal sets data transmission power necessary for communicating with the server, corresponding to the frequency band information.

After operation 302, the wireless terminal transmits the GPS coordinate information to the server according to the set frequency band and transmission power (304). The wireless terminal may transmit the received GPS coordinate information to the server through the LPWAN.

Meanwhile, in the operation 300, when it is determined that frequency band information mapped with the GPS coordinate information is not present, the wireless terminal increases a wake-up cycle for operation of the wireless terminal (306). When the frequency band information mapped with the received GPS coordinate information is not present in the wireless terminal, the corresponding wireless terminal may be located in a region incapable of receiving GPS coordinate information. In this case, when a wake-up mode and a sleep-mode are repeated at a general wake-up cycle, power of the wireless terminal may be unnecessarily consumed. Accordingly, in this case, power consumption of the wireless terminal may be minimized by increasing the wake-up cycle of the wireless terminal. The wireless terminal is set to repeatedly perform the wake-up mode and the sleep mode at a time interval increased than that of a preset cycle. The wireless terminal may be set to allow the wake-up cycle to geometrically increase. Also, the wireless terminal may change the wake-up cycle when a certain times of such wake-up modes have repeated.

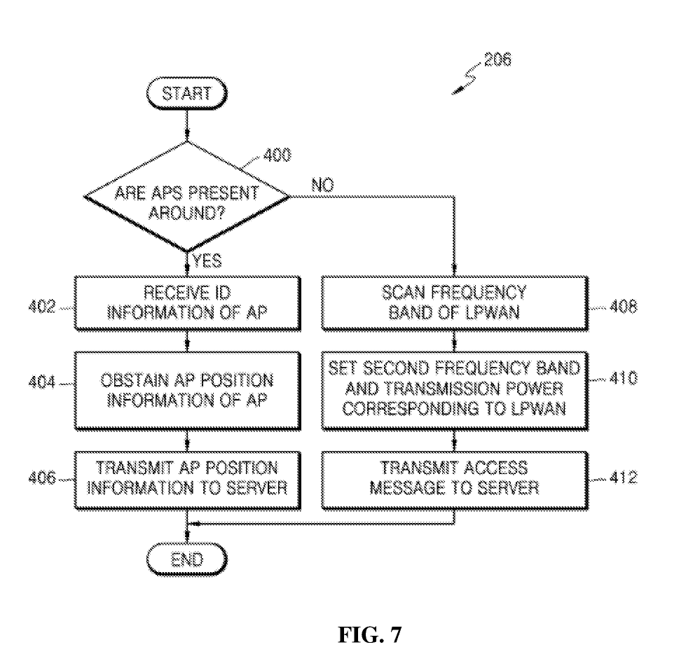

FIG. 7 is a flowchart illustrating operation 206 of accessing the server of the LPWAN and transmitting position information of the AP thereto, which is shown in FIG. 5.

Referring to FIG. 7, when the GPS coordinate information is not received, the wireless terminal determines whether APs are present around (400). The wireless terminal checks whether an AP is present by scanning around.

In operation 400, when an AP is present, the wireless terminal receives ID information of the AP (402). Here, the ID information may include a BSSID of the AP and an IP address of the AP.

After operation 402, the wireless terminal obtains AP position information of the AP by using the received ID information (404). The wireless terminal checks whether the AP, which transmits the ID information, is an open AP. When the AP, which transmits the ID information, is an open AP, the wireless terminal may access the open AP and obtain AP position information corresponding to the BSSID. That is, the wireless terminal may obtain the AP position information corresponding to the BSSID from a position providing server connected to the accessed open AP through a communication network. Also, when the AP, which transmits the ID information, is not an open AP, the wireless terminal checks whether AP position information corresponding to the IP address of the ID information is stored in the wireless terminal. When the AP position information corresponding to the IP address is present in the wireless terminal, it is possible to obtain the AP position information corresponding to the AP.

After operation 404, the wireless terminal transmits the obtained AP position information of the AP to the server (406). The wireless terminal may transmit the obtained AP position information of the AP to the server through the LPWAN.

Meanwhile, when an AP is not present around, the wireless terminal scans a frequency band of the LPWAN serviced by the server (408). The wireless terminal may perform the scanning operation with respect to the frequency band of the LPWAN for a certain time or more. The wireless terminal may search for the frequency band of the LPWAN, that is, a second frequency band through frequency scanning.

After operation 408, the wireless terminal sets the second frequency band and transmission power corresponding to the frequency band of the LPWAN searched for according to the scanning of the frequency band (410). The wireless terminal sets the searched frequency band of the LPWAN, that is, the second frequency band as a frequency band for transmitting and receiving data. Then, the wireless terminal may set transmission power for data transmission to correspond to the set frequency band.

After operation 410, the wireless terminal transmits an access message to the server according to the set frequency band and transmission power (412). The wireless terminal generates an access message for accessing the server which provides services through the LPWAN. Here, the access message may be a request signal for access of the wireless terminal to the server, a service request signal, or the like. The wireless terminal transmit the generated access message to the server through the LPWAN according to the set second frequency band and transmission power.

Accordingly, the above-described wireless terminal according to one embodiment of the present invention quickly provides position information of the wireless terminal to the server which services the LPWAN by using GPS coordinate information or position information of an AP such that the corresponding wireless terminal may perform quick communication with the server. That is, even when the wireless terminal, which operates on an unlicensed frequency band, moves to a region in which a different unlicensed frequency band is serviced, the wireless terminal checks corresponding position information in a wake-up mode and transmits the position information to a server which services the LPWAN such that services using the LPWAN between the wireless terminal and the server may be quickly performed. For example, when the wireless terminal located in Korea moves to the U.S.A., the wireless terminal, which operates on an unlicensed frequency band of 932 MHz corresponding to an LPWAN in Korea, quickly transmits GPS coordinate information corresponding to position information of the wireless terminal or position information of an AP to operate on the unlicensed frequency band of 902 MHz corresponding to an LPWAN in the U.S.A. such that the wireless terminal may quickly access a server which services the LPWAN with a different unlicensed frequency band.

According to the embodiments of the present invention, position information of a wireless terminal is quickly provided to a server which services an LPWAN among unlicensed frequency bands by using at least one of GPS coordinate information received from a satellite and AP position information of an AP for accessing a network of the unlicensed frequency band such that the corresponding wireless terminal may quickly access the server which services the LPWAN.

The exemplary embodiments of the present invention have been described above. One of ordinary skill in the art can understand that modifications may be made without departing from the essential properties of the present invention. Therefore, the disclosed embodiments should be considered in a descriptive aspect not in a limitative aspect. The scope of the present invention is defined by the claims not by the above description, and it should be understood that all differences within the equivalents thereof are included in the present invention.

What is claimed is:

1. A wireless terminal comprising:
a global positioning system (GPS) communication portion which receives GPS coordinate information from a satellite;
a wireless fidelity (Wi-Fi) communication portion configured to transmit and receive data by using a first frequency band among unlicensed frequency bands for wireless communications;
a low-power wide-area network (LPWAN) communication portion configured to transmit and receive data by using a second frequency band corresponding to an LPWAN among the unlicensed frequency bands;
an information storage portion configured to store frequency band information mapped with the GPS coordinate information received from the GPS communication portion;
a power supply portion configured to supply power for operations of the GPS communication portion, the Wi-Fi communication portion, and the LPWAN communication portion; and
a control portion configured to control the GPS communication portion, the Wi-Fi communication portion, the LPWAN communication portion, the information storage portion, and the power supply portion,
wherein the control portion controls the LPWAN communication portion to access a server which services the LPWAN by using at least one of the frequency band information mapped with the GPS coordinate information and access point (AP) position information of an AP which the Wi-Fi communication accesses.

2. The wireless terminal of claim 1, wherein the second frequency band comprises at least one of 865 GHz, 868 GHz, 902 GHz, 916 GHz, 920 GHz, 923 GHz, and 925 GHz.

3. The wireless terminal of claim 1, wherein when the frequency band information mapped with the received GPS coordinate information is present in the information storage portion, the control portion sets a frequency band and transmission power for accessing the server by using the mapped frequency band information and performs control to transmit the GPS coordinate information to the server according to the set frequency band and transmission power.

4. The wireless terminal of claim 1, wherein when frequency band information mapped with the received GPS coordinate information is not present in the information storage portion, the control portion performs control to increase a wake-up cycle for operation of the wireless terminal.

5. The wireless terminal of claim 1, wherein when the GPS coordinate information is not received from the GPS communication portion, the control portion determines whether the AP is present around, and
wherein when identifier (ID) information of the AP is received from the AP through the Wi-Fi communication portion, the control portion obtains the AP position information with respect to the AP and performs control to transmit the obtained AP position information to the server.

6. The wireless terminal of claim 5, wherein when the ID information comprises at least one of a basic service set ID (BSSID) and an Internet protocol (IP) address of the AP, the control portion performs control to obtain the AP position information corresponding to the BSSID by accessing an open AP or performs control to obtain the AP position information corresponding to the ID address stored in the information storage portion.

7. The wireless terminal of claim 5, wherein when the ID information of the AP is not obtained through the Wi-Fi communication portion, the control portion controls the LPWAN communication portion to scan a frequency band of the LPWAN and performs control to transmit an access message to the server according to transmission power corresponding to the frequency band of the LPWAN, which is searched for according to scanning.

8. A communication method of a wireless terminal, comprising:
determining whether a wake-up event occurs;
determining whether GPS coordinate information is received from a satellite when it is determined that the wake-up event has occurred; and
accessing a server which services an LPWAN among unlicensed frequency bands by using at least one of frequency band information mapped with the GPS coordinate information and AP position information of an AP which services the unlicensed frequency bands, according to whether the GPS coordinate information is received.

9. The method of claim 8, wherein the accessing the server comprises:
determining whether the frequency band information mapped with the GPS coordinate information is present when the GPS coordinate information is received;
setting a frequency band and transmission power for accessing the server by using the mapped frequency band information when the frequency band information mapped with the GPS coordinate information is present; and
transmitting the GPS coordinate information to the server through the LPWAN according to the set frequency band and transmission power.

10. The method of claim 9, wherein the accessing the server further comprises increasing a wake-up cycle for operation of the wireless terminal when the frequency band information mapped with the GPS coordinate information is not present.

11. The method of claim 8, wherein the accessing the server further comprises:
determining whether the AP is present around when the GPS coordinate information is not received;
receiving ID information of the AP from the AP when the AP is present;
obtaining the AP position information with respect to the AP by using the received ID information; and
transmitting the obtained AP position information to the server.

12. The wireless terminal of claim 11, wherein the obtaining of the AP position information with respect to the AP by using the received ID information comprises, when the ID information comprises at least one of a BSSID and an IP address of the AP, obtaining the AP position information corresponding to the BSSID by accessing an open AP or obtaining the AP position information corresponding to the ID address stored in the wireless terminal.

13. The method of claim 11, wherein the accessing the server further comprises:
scanning a frequency band of the LPWAN when the AP is not present;
setting a second frequency band and transmission power corresponding to the frequency band of the LPWAN, which is searched for according to scanning of the frequency band; and
transmitting an access message to the server according to the set frequency band and transmission power.
